(19) United States
(12) Patent Application Publication
(10) Pub. No.: US 2024/0305622 A1
(43) Pub. Date: Sep. 12, 2024

(54) PROVISIONING AND SECURE ACCESS CONTROL FOR STORAGE ON PUBLIC SERVERS

(71) Applicant: Salesforce, Inc., San Francisco, CA (US)

(72) Inventors: Siby Vijayan, Bangalore (IN); Eric Fox, Bellevue, WA (US)

(21) Appl. No.: 18/118,263

(22) Filed: Mar. 7, 2023

(51) Int. Cl. H04L 9/40

(52) U.S. Cl. CPC H04L 63/0823; H04L 63/10

(57) ABSTRACT

Systems, devices, and techniques are disclosed for provisioning and secure access control for storage on public servers. Data may be received from a tenant service identifying both the tenant service and a security certificate. A data storage container may be generated on a public server. A security role that is associated with the tenant service and includes permissions for accessing data in the data storage container may be generated on the public server. A request to access the data storage container may be received from the tenant service, including an identification of the tenant service and the security certificate. Credentials and a request to assume the security role may be sent to an identity provider. A temporary security token for accessing the data storage container with the permissions of the security role may be received from the public server. The temporary security token may be sent to the tenant service.

### BACKGROUND

Enterprise applications may use BLOB storage hosted on public cloud servers to store large amounts of data. Provisioning and using BLOB storage on a public cloud server may be difficult to do in a manner that is compliant with the security needs of an enterprise-level security compliant way in production. It may also be difficult to share data stored in BLOB storage on public cloud servers among different teams within an enterprise due to the required security policies that need to be created for each trust relationship between the consumers of the stored data and producers of the stored data. This can result in data-silos within an enterprise.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for provisioning and secure access control for storage on public servers according to an implementation of the disclosed subject matter.

FIG. 2 shows an example arrangement suitable for provisioning and secure access control for storage on public servers according to an implementation of the disclosed subject matter.

FIG. 3A shows an example arrangement suitable for provisioning and secure access control for storage on public servers according to an implementation of the disclosed subject matter.

FIG. 3B shows an example arrangement suitable for provisioning and secure access control for storage on public servers according to an implementation of the disclosed subject matter.

FIG. 4A shows an example arrangement suitable for provisioning and secure access control for storage on public servers according to an implementation of the disclosed subject matter.

FIG. 4B shows an example arrangement suitable for provisioning and secure access control for storage on public servers according to an implementation of the disclosed subject matter.

FIG. 5 shows an example arrangement suitable for provisioning and secure access control for storage on public servers according to an implementation of the disclosed subject matter.

FIG. 6A shows an example arrangement suitable for provisioning and secure access control for storage on public servers according to an implementation of the disclosed subject matter.

FIG. 6B shows an example arrangement suitable for provisioning and secure access control for storage on public servers according to an implementation of the disclosed subject matter.

FIG. 7 shows an example arrangement suitable for provisioning and secure access control for storage on public servers according to an implementation of the disclosed subject matter.

FIG. 8A shows an example arrangement suitable for provisioning and secure access control for storage on public servers according to an implementation of the disclosed subject matter.

FIG. 8B shows an example arrangement suitable for provisioning and secure access control for storage on public servers according to an implementation of the disclosed subject matter.

FIG. 9 shows an example procedure suitable for provisioning and secure access control for storage on public servers according to an implementation of the disclosed subject matter.

FIG. 10 shows an example procedure suitable for provisioning and secure access control for storage on public servers according to an implementation of the disclosed subject matter.

FIG. 11 shows a computer according to an implementation of the disclosed subject matter.

FIG. 12 shows a network configuration according to an implementation of the disclosed subject matter.

### DETAILED DESCRIPTION

Techniques disclosed herein enable provisioning and secure access control for storage on public servers, which may allow for storage on a public server to be provisioned for tenant services and for access to the data stored on the public server to be controlled in a secure manner. A data store service may receive data identifying both a tenant service and a first security certificate from a tenant service. The data store service may generate a data storage container that stores data on a physical storage of a public server. The data store service may generate on the public server a security role that is associated with the tenant service and comprises a set of permissions for accessing data in the data storage container. The data store service may receive from the tenant service a request to access the data storage container on the public server. The request may include an identification of the tenant service and the first security certificate. The data store service may send to an identity provider credentials and a request to assume the security role. The data store service may receive from the public server a temporary security token that allows access to the data storage container based on the set of permissions of the security role. The data store service may send the temporary security token to the tenant service.

A data store service may receive data identifying both a tenant service and a first security certificate from a tenant service. A cloud computing server system may be a multi-tenant system that may have any number of tenants. Each tenant of the cloud computing server may run any number of tenant services within its own working environment on the cloud computing server system. The working environment for a tenant on the cloud computing server system may be configured with user interfaces, applications, and tenant services for the tenant, and may be separate from working environments for other tenants on the cloud computing server system. A tenant may be, for example, a business, enterprise, organization, or other such entity. A data store service may run on the cloud computing server system, either within the working environment for a tenant, or as a service that is accessible to services that run within working environments for multiple tenants. The data store service may receive setup data from a tenant service that identifies both the tenant service and a minimum of one security certificate. The setup data may be sent by the tenant service to the data store service in any suitable manner, such as, for example, through an API of the data store service, and may be in any suitable format, including, for example, JSON format. The setup data sent to the data store service may identify the tenant service and the security certificates in any suitable manner. For example, the tenant service may be identified by name, and security certificates may be identified by name or through regular expressions that may be matched to the names of mTLS certificates, or through URI's. The tenant service may send the setup data to the data store service as part of a request that the data store service provision storage on a public server on behalf of the tenant service.

The data store service may generate a data storage container that stores data on a physical storage of a public server. The data store service may include a provisioning service. The provisioning service may provision a data storage container on a public server. The public server may be a publicly accessible cloud computing server system, which may be different from, or a different portion of, the cloud computing server system that runs the data store service. The data storage container may be, for example, BLOB storage bucket. If the tenant service is the first tenant service belonging to its tenant to have a data storage container provisioned, the provisioning service may request that the public server provision a new data storage container. If another tenant service belonging to the same tenant has already had a data storage container provisioned on the public server, the provisioning service may request new key prefix to be used with the already provisioned data storage container. The public server may, in response to the request from the provisioning service, provision the request data storage container or new key prefix to be used with an already existing data storage container.

The data store service may generate on the public server a security role that is associated with the tenant service and comprises a set of permissions for accessing data in the data storage container. The provisioning service of the data storage service may generate a security role on the public server that may be include a set of permissions that allow access to the data stored in the data storage container. The security role may be generated with, for example, an identity provider of the public server. The identity provider of the public server may be a component of the public server that allows entities to verify their identity to the public server with credentials that may not have been issued by the public server itself. The provisioning service may cause the identity provider to associate the security role with the tenant service from which the data store service received the setup data and to allow the data store service to assume the security role on behalf of the tenant service. The security role may, for example, include a set of permissions allowing the reading of data from and writing of data to the data storage container. The set of permissions may also be granular, for example, restricting read/write access to data in the data storage container based on a specified key prefix used in the filenames of files stored in the data storage container. The use of key prefixes may allow multiple tenant services that run in the same tenant's working environment to store data in the same data storage container on the public server while maintaining data access segregation, so that each tenant service may only be able to access its own data unless given permission by another tenant service to access that tenant service's data. The data store service may also store any necessary configuration data for the data storage container in a configuration container on the public server.

The data store service may receive from the tenant service a request to access the data storage container on the public server. The request may include an identification of the tenant service and the first security certificate. A tenant service on whose behalf the data store service provisioned a data storage container, or new key prefix for an existing data storage container, may send a request for access to that data storage container to the data store service. The request may include an identification of the tenant service, which may be the name of the tenant service that was sent to the data store service in the setup data, The request may include a security certificate, which may be one of the security certificates that was identified in the setup data sent to the data service.

The data store service may send to an identity provider credentials and a request to assume the security role. The data store service may include a permissions service. The permissions service may check the name of the tenant service and security certificate received from the tenant service to determine if the security certificate was named in the setup data received from the named tenant service. If the security certificate was not named in the setup data received from the named tenant service, which may be due to either the security certificate or the name of the tenant service being incorrect, the permissions service may deny access to the tenant service that sent the request to access the data storage container. This may prevent other tenant services from accessing the data storage container unless they have security certificates that were named in the setup data provided to the data store service and know the name of the tenant service that provided the setup data. If the security certificate was named in the setup data received from the named tenant service, the permissions service may send credentials that prove the identity of the data store service to the identity provider of the public server along with a request to assume the security role that allows access to the data storage container. This may be the security role associated with the tenant service that provided the setup data. The identity provider may verify the identity of the data store service and allow the data store service to assume the security role. The data store service may provide any suitable credentials to prove its identity to the identity provider of the public server.

The data store service may receive from the public server a temporary security token that allows access to the data storage container based on the set of permissions of the security role. After being permitted to assume the security role that has permission to access the data storage container, the permissions service may request a temporary security token from a token provider of the public server. The temporary security token may be a token, in any suitable format, that may be presented to the public server to gain access to the data storage container using the set of permissions of the security role that was assumed by the requester of the temporary security token. For example, the temporary security token may allow access to files in the data storage container that include a specific key prefix. The token provider may generate and send the temporary security token to the permissions service. The temporary security token may be valid for any suitable amount of time, during which it may be used to access the data storage container, before expiring.

The data store service may send the temporary security token to the tenant service. The data store service may send the temporary security token that was received from the token provider of the public server to the tenant service that requested access to the data storage container. Along with the temporary security token, the data store service may send the tenant service any configuration data that may be needed to allow the tenant service to access the data storage container on the public server, such as, for example, a name of the data storage container, a base folder of the data storage container, and a region of the public server where the data storage container is located. The tenant service may then use the temporary security token and configuration data to access the data storage container on the public server for as long as the temporary security token is valid, working with data as allowed by the set of permissions of the security role that was assumed by the data store service in order to request the temporary security token.

Any cryptographic keys used for encrypting and decrypting data stored in a data storage container provisioned by the data store service may be managed by a key management service of the public server. The only credentials that may need to be stored outside of the public server to allow tenant services in a working environment to access a data storage container provisioned on their behalf may be the credentials used by the data store service to prove its identity to the identity provider of the public server, allowing it to assume security roles.

Multiple tenant services belonging to the same tenant and running in the same working environment on the cloud computing server system may share a data storage container on the public server. After the data store service has provisioned a data storage container for one of the tenant services running in a working environment, other tenant services from that working environment may send their own setup data to the data store service that identifies both the tenant service sending the setup data, for example, by name, and any number of security certificates. The data store service may, for each such tenant service, generate a security role with the identity provider of the public server that allows access to the already provisioned data storage container. The security role associated with each tenant service may include a set of permissions that allows access to files in the data storage container based on key prefixes. Each security role may be associated with a different key prefix that may be used in the file names of files stored in the data storage container. This may allow, for example, two tenant services from the same working environment to both store data in the same data storage container with access control enforced by the security roles associated with each tenant service and the key prefixes associated with the security roles. The temporary security token obtained by the data store service by assuming the security role that is associated with the first of the two tenant services may allow access to files in the data storage container that include in their filenames the key prefix associated with that security role, including forcing newly written files to include that key prefix and preventing the inclusion of any other key prefix. Thus, a tenant service that receives the temporary security token obtained by the data store service by assuming the security role that is associated with the first of the two tenant services may have access to data in the data storage container limited based on the key prefix associated with the security role. Similarly, the temporary security token obtained by the data store service by assuming the security role that is associated with the second of the two tenant services may allow access to files in the data storage container that include in their filenames the key prefix associated with that security role, including forcing newly written files to include that key prefix and preventing the inclusion of any other key prefix.

A tenant service may permit other tenant services to access a data storage container with the security role associated with the tenant service. The other tenant services may include both other tenant services belonging to the same tenant and running in the same working environment as the tenant service, and tenant services belonging to other tenants running in other working environments in the cloud computing server system. For example, a first tenant service may provide a second tenant with both the name of the first tenant service and a security certificate that was identified to the data store service by the first tenant service in the setup data that the first tenant service sent to the data store service. Alternatively, the first tenant service may have identified a security certificate that the second tenant service already possesses, or could obtain from elsewhere, in the setup data that was sent to the data store service. The second tenant service may then send the name of the first tenant service and the security certificate to the data store service. The data store service may verify that the security certificate was identified in the setup data sent to the data store service by the first tenant service, and may then assume the role on the public server of the first tenant service, obtaining a temporary security token that can be used to access the data storage container on the public server based on permissions of the security role associated with the first tenant service. This temporary security token may be sent to the second tenant service which use it to access the data storage container on the public server. The temporary security token may allow the second tenant service to have the same permissions that the first tenant service would have in accessing the data storage container, for example, allowing access to files that include the key prefix associated with the security role associate with the first tenant service.

A tenant service may permit other tenant services to access a data storage container with a secondary security role associated with the tenant service. A first tenant service, when sending setup data to the data store service, may request the data store service generate a secondary security role associated with the first tenant service that has a different set of permissions than the set of permissions for a primary security role associated with the first tenant service. The secondary security role may also be associated with any number of security certificates, identified in the setup data, for example, by name or regular expression, that may not be associated with the primary security role. The data store service may receive from a tenant service a request to access to the data storage container used by the first tenant service. The request may include the name of the first tenant service and a security certificate associated with the secondary security role associated with the first tenant service. The data store service may determine that the security certificate sent in the request is associated with the secondary security role and may assume the secondary security role instead of the primary security role on the public server. This data store service may obtain a temporary security token that allows access to the data storage container based on the set of permissions of the secondary security role, which may be different than the set of permissions of the primary security role. The temporary security token may be sent to the tenant service that requested access to the data storage container, which may be the first tenant service or another tenant service. That tenant service may use the temporary security token to access the data storage container on the public sever with the permissions of the secondary security role. A tenant service may have any number of security roles associated with it on the public server, each having its own set of permissions for access to the data storage container that may be any subsets of the sets of permissions of a primary security role associated with the tenant service. For example, the primary security role associated with a tenant service may provide full read/write access to the data storage container limited only by the key prefix associated with the primary security role. A secondary security role may be read-only access to the data storage container limited by the key prefix associated with the primary security role.

In some implementations, different security roles associate with the same tenant service may be associated with different key prefixes and may also be associated with multiple key prefixes. This may allow for a tenant service to have fine grained control over the sharing of its data in the data storage container. For example, the primary security role may be associated with all key prefixes that are associated with any security role associated with the tenant service, while a secondary security role may only be associated with some subset of those key prefixes. This may limit the access of any tenant service that uses a temporary security token that has the permissions of the secondary security role.

In some implementations, the provisioning service may provision structured storage on the public server. In some implementations, the data store service may be used to provision and provide secure access to other services offered by the public server. The public server may include services that may be accessed using temporary tokens. The data service may on request from a tenant service generate a security role that may allow the data store service to a obtain temporary token that can be used to securely access a service of public server. The data store service may then obtain and provide the temporary token to the tenant service when the tenant service wishes to access the service on the public server, in the same manner that the data store service obtains and provides to tenant services temporary tokens for access to data storage containers.

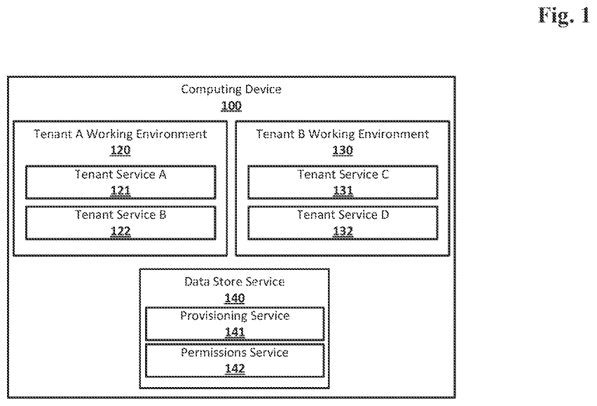

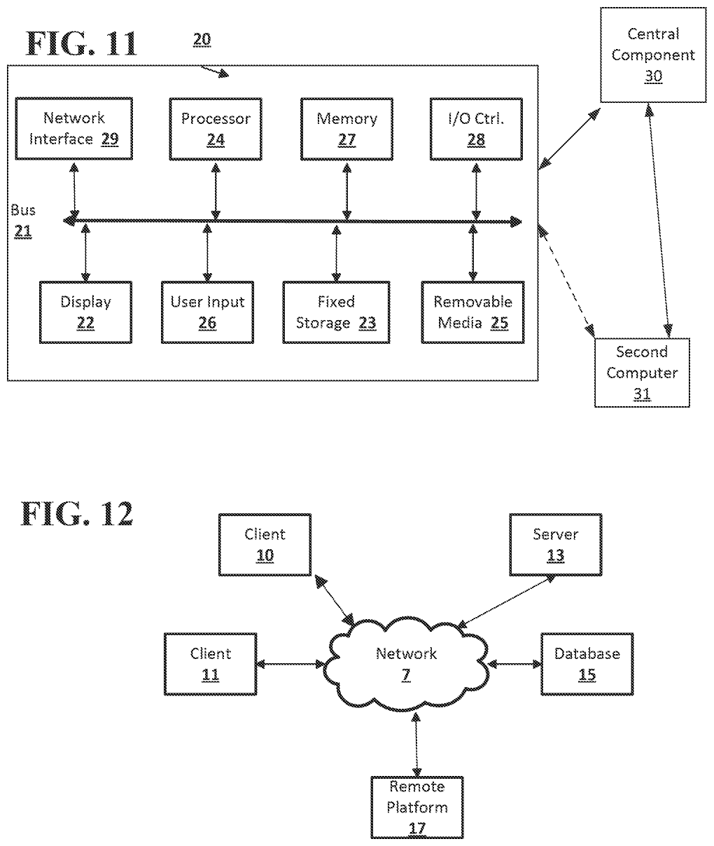

FIG. 1 shows an example system suitable for provisioning and secure access control for storage on public servers according to an implementation of the disclosed subject matter. A computing device 100 may be, for example, the computer 20 as described in FIG. 11, or components thereof. The computing device 100 may include any number computing devices, each of which may include any suitable combination of central processing units (CPUs), graphical processing units (GPUs), and tensor processing units (TPUs). The computing device 100 may be distributed over any geographic area, and may, for example, include geographically disparate computing devices connected through any suitable network connections. The computing device 100 may be, or be a part of, a cloud computing server system that may support multi-tenancy.

The computing device 100 may include the tenant A working environment 120 and the tenant B working environment 130, which may be software running on the computing device 100 that may be used by tenants of the computing device 100 to access the computational resources of the computing device 100. The tenant A working environment 120 may belong to a tenant A, and may be used by users associated with the tenant A. The tenant B working environment 130 may belong to a tenant B, and may be used by users associated with the tenant B. The tenant A working environment 120 and the tenant B working environment 130 working environments may be configured with user interfaces, applications, and tenant services for the respective tenant A and tenant B.

The tenant A working environment 120 may include tenant service A 121 and tenant service B 122. The tenant B working environment 130 may tenant service C 131 and tenant service D 132. The tenant service A 121, tenant service B 122, tenant service C 131, and tenant service D 132 may be services running in their respective working environments that may make available any suitable services through, for example, API interfaces, including, for example, services that read, write, and modify data stored for their respective tenants.

The computing device 100 may include the data store service 140. The data store service 140 may be a service that runs on the computing device 100 either within working environments or outside of, but accessible to, working environments on the computing device 100. The data store service 140 may be a service that may handle the provisioning of and secure access control to data storage containers on a public server that are used by the tenants of the computing device 100, for example, by the services running in the tenant A working environment 120 and the tenant B working environment 130. The data store service 140 may include a provisioning service 141 and a permissions service 142. The provisioning service 141 may be a service that may use received setup data, including identifications of a tenant service name and a minimum of one security certificate, to provision data security containers on a public server, including security roles used to access the provisioned data storage container. The permissions service 142 may be a service that may control access to provisioned data storage containers on the public server by tenant services on the computing device 100.

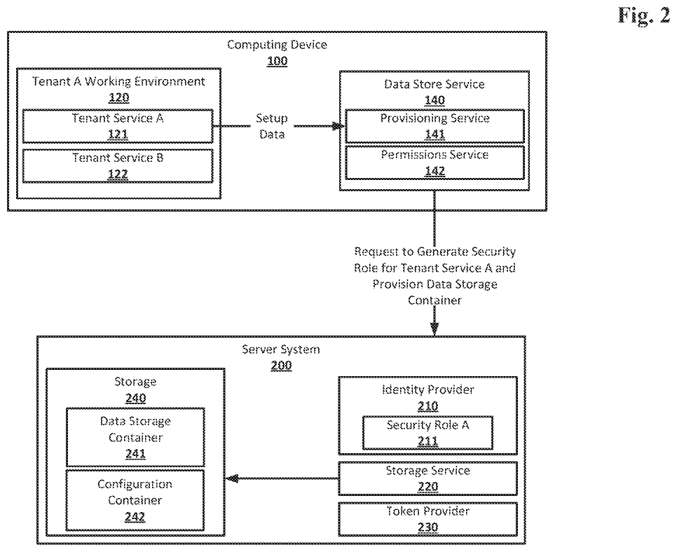

FIG. 2 shows an example arrangement suitable for provisioning and secure access control for storage on public servers according to an implementation of the disclosed subject matter. The tenant service A 121 may send setup data to the provisioning service 141 of the data store service 140. The setup data may include an identification of the tenant service A 121, for example, the service name “Service A”, and an identification of a minimum of one security certificate, for example, a security certificate with an Organizational Unit (OU) field of “tenantA.serviceA”. The setup data may identify security certificates in any suitable manner, including, for example, text or regular expressions that may be matched against any fields in the security certificate or through URIs. The provisioning service 141 may send a request to a server system 200 to provision a data storage container for the tenant service A 121 and generate a security role associated with the tenant service A 121 that can be used to access the data storage container. The provisioning service 141 may also store an association between the tenant service and security certificates in the setup data.

The server system 200 may be a public server system that may include computing devices such as, for example, the computer 20 as described in FIG. 11, or components thereof. The server system 200 may include any number computing devices, each of which may include any suitable combination of central processing units (CPUs), graphical processing units (GPUs), and tensor processing units (TPUs). The server system 200 may be distributed over any geographic area, and may, for example, include geographically disparate computing devices connected through any suitable network connections. The server system 200 may be publicly accessible, for example, may be available for use by the general public any may not be restricted to use by specific businesses, organization, or entities.

The server system 200 may include an identity provider 210, a storage service 220, token provider 230, and a storage 240. The identity provider 210 may be a service of the server system 200 that may verify identities of users attempting to access the server system 200. The storage service 220 may be a service of the server system 200 that may manage the usage of storage space in the storage 240 by users of the server system 200. The token provider 230 may be a service of the server system 200 that may generate temporary security tokens that may be used by users of the server system 200 to gain access to services provided by the server system 200, including, for example, the storage service 220. The server system 200 may also include a storage 240, which may be any suitable combination of hardware and software, including physical storage media of any suitable type, for storing data on the server system 200.

The request from the provisioning service 141 to provision a data storage container for the tenant service A 121 and generate a security role associated with the tenant service A 121 that can be used to access the data storage container may be received at the server system 200. The storage service 220 may provision a data storage container 241 in the storage 240 of the server system 200. The data storage container 241 may be, for example, an unstructured storage container, such as a BLOB storage bucket, that may be used for storing data in files in an unstructured manner. The storage service 220 may also set up a configuration container 242, which may store configuration data for the data storage container 241. In some implementations, the data storage container 241 may be structured storage.

The identity provider 210 may generate a security role A 211. The security role A 211 may be a security role on the sever system 200 that may have a set of permissions allow and delimit access to the data storage container 241 for any user of the security role A 211. For example, the security role A 211 may permit read/write access to the data storage container 241 delimited by a key prefix associated with the security role A 211, such that any file stored in the data storage container 241 by a user using the security role A 211 must include that key prefix in the file name and the user may only read and modify files with that key prefix in their filenames. The security role A 211 may be associated with the tenant service A 121, and may have a policy set, for example, by the data store service 140, that may allow the data store service 140, through the permissions service 142, to assume the security role A 211 on the server system 200. The data store service 140 may set a policy in the configuration container 242 that delegates to the permissions service 142. The data store service 140 may also save configuration settings and permissions for the tenant service A 121 to the configuration container 242. Any cryptographic keys used to encrypt and decrypt data in the data storage container 241 may remain stored on the server system 200 and may be managed by, for example, a key management service of the server system 200.

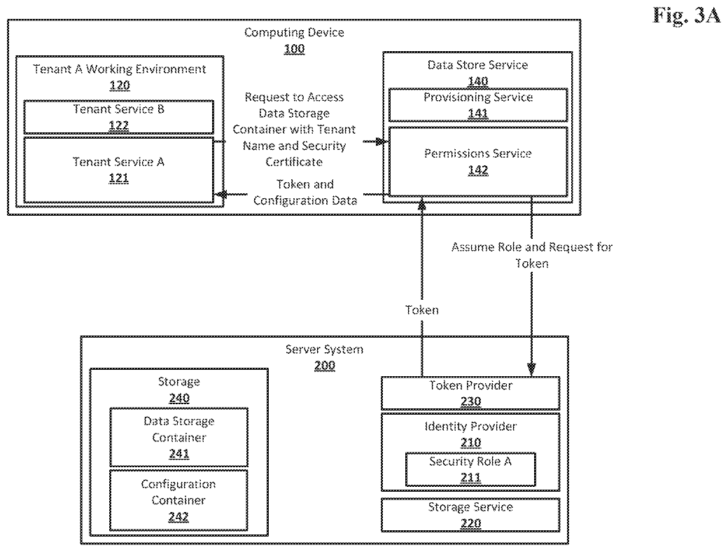

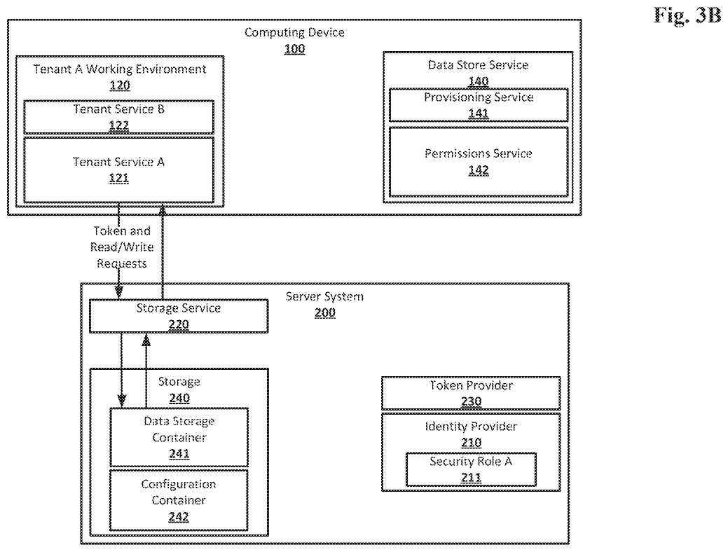

FIG. 3A shows an example arrangement suitable for provisioning and secure access control for storage on public servers according to an implementation of the disclosed subject matter. The tenant service A 121 may send a request to access the data storage container provisioned for it to the permissions service 142 of the data store service 140. The request sent by the tenant service A 121 may include the name of the tenant service whose data the tenant service A 121 wants access to, for example, the “Service A”, and a security certificate that was identified in the setup data that was sent to the data store service 140 by the tenant service whose data the tenant service A 121 wants access to, for example, the security certificate with an OU field of “tenantA.serviceA.”

The permissions service 142 may determine whether the security certificate received from the tenant service A 121 is valid, and whether it was identified in the setup data provided by the tenant service named in the request by the tenant service A 121. For example, the permissions service 142 may determine that the security certificate with the OU field of “tenantA.serviceA” was both identified in the setup data sent by the tenant service named “Service A”, the tenant service A 121, and is valid. The permissions service 142 may then assume the security role associated with the tenant service A 121 on the server system 200, the security role A 211. The permissions service 142 may, for example, prove its identity to the identity provider 210, which may then determine that the policy attached to the security role A 211 permits the permissions service 142 to assume the security role A 211. Using the security role A 211, the permissions service 142 may request a temporary security token that allows access to the data storage container 241 from the token provider 230. The token provider 230 may generate a temporary security token that may allow access to the data storage container 241 based on the set of permissions of the security role A 211. The temporary security token may also have an expiration time. The temporary security token may be sent to the permissions service 142 which may provide the temporary security token and configuration data for the data storage container 241 to the tenant service A 121.

FIG. 3B shows an example arrangement suitable for provisioning and secure access control for storage on public servers according to an implementation of the disclosed subject matter. The tenant service A 121 may use the temporary security token received from the permissions service 142 to interact with the data storage container 241 on the server system 200 using the set of permissions from the security role A 211. The tenant service A 121 may send the temporary security token to the storage service 220 along with any read/write requests for the data storage container 241. The storage service 220 may allow the tenant service A 121 to interact with the data storage container 241 based on the set of permissions of the security role A 211. For example, the storage service 220 may allow the tenant service A 121 to read and modify files in the data storage container 241 that include in their filenames the key prefix that is associated with the security role A 211, and may add this key prefix to the filenames of any new files written to the data storage container 241 by the tenant service A 121. The storage service 220 may prevent the tenant service A 121 from accessing files in the data storage container 241 that permissions of the security role A 211 do not permit access to, for example, files stored with other key prefixes in their filenames, as well as files in other data storage containers in the storage 240. The tenant service A 121 may access the data storage container 241 using the temporary security token until the temporary security token expires, at which time the tenant service A 121 may need to obtain another temporary security token through the permissions service 142 to again access the data storage container 241.

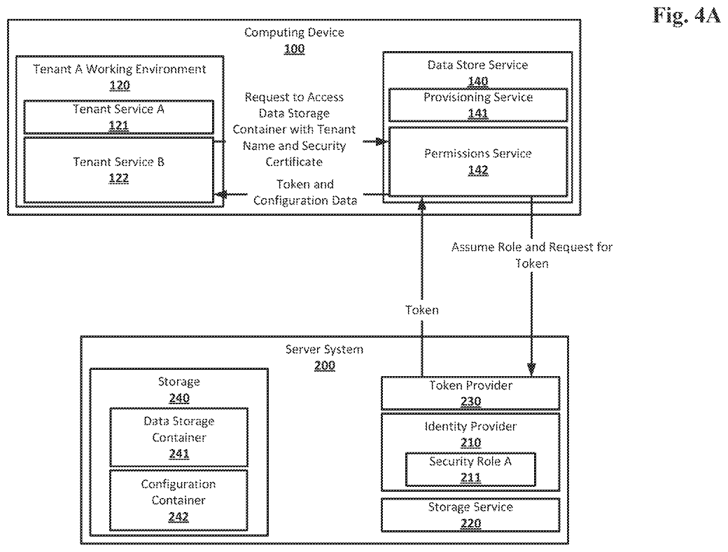

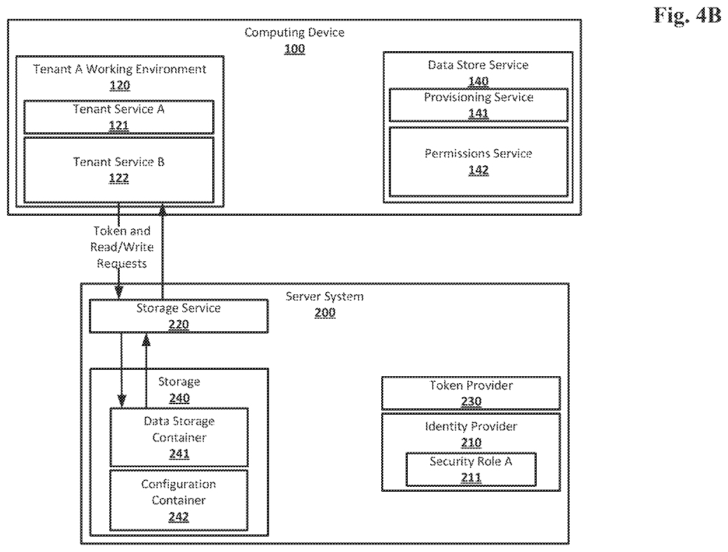

FIG. 4A shows an example arrangement suitable for provisioning and secure access control for storage on public servers according to an implementation of the disclosed subject matter. The tenant service B 122 may send a request to access the data storage container provisioned for the tenant service A 121 to the permissions service 142 of the data store service 140. The request sent by the tenant service B 122 may include the name of the tenant service whose data the tenant service B 122 wants access to, for example, the “Service A”, and a security certificate that was identified in the setup data that was sent to the data store service 140 by the tenant service whose data the tenant service B 122 wants access to, for example, a security certificate with an OU field of “tenantA.serviceB.” For example, the tenant service A 121 may have identified the security certificate with an OU field of “tenantA.serviceB” in the setup data it sent to the data store service 140 in order to allow the tenant service B 122 access to data stored by the tenant service A 121 in the data storage container 241.

The permissions service 142 may determine whether the security certificate received from the tenant service B 122 is valid, and whether it was identified in the setup data provided by the tenant service named in the request by the tenant service B 122. For example, the permissions service 142 may determine that the security certificate with the OU field of “tenantA.serviceB” was both identified in the setup data sent by the tenant service named “Service A”, the tenant service A 121, and is valid. The permissions service 142 may then assume the security role associated with the tenant service A 121 on the server system 200, the security role A 211. The permissions service 142 may, for example, prove its identity to the identity provider 210, which may then determine that the policy attached to the security role A 211 permits the permissions service 142 to assume the security role A 211. Using the security role A 211, the permissions service 142 may request a temporary security token that allows access to the data storage container 241 from the token provider 230. The token provider 230 may generate a temporary security token that may allow access to the data storage container 241 based on the set of permissions of the security role A 211. The temporary security token may also have an expiration time. The temporary security token may be sent to the permissions service 142 which may provide the temporary security token and configuration data for the data storage container 241 to the tenant service B 122.

FIG. 4B shows an example arrangement suitable for provisioning and secure access control for storage on public servers according to an implementation of the disclosed subject matter. The tenant service B 122 may use the temporary security token received from the permissions service 142 to interact with the data storage container 241 on the server system 200 using the set of permissions from the security role A 211. The tenant service B 122 may send the temporary security token to the storage service 220 along with any read/write requests for the data storage container 241. The storage service 220 may allow the tenant service B 122 to interact with the data storage container 241 based on the set of permissions of the security role A 211. For example, the storage service 220 may allow the tenant service B 122 to read and modify files in the data storage container 241 that include in their filenames the key prefix that is associated with the security role A 211, and may add this key prefix to the filenames of any new files written to the data storage container 241 by the tenant service B 122. The storage service 220 may prevent the tenant service B 122 from accessing files in the data storage container 241 that permissions of the security role A 211 do not permit access to, for example, files stored with other key prefixes in their filenames, as well as files in other data storage containers in the storage 240. The tenant service B 122 may access the data storage container 241 using the temporary security token until the temporary security token expires, at which time the tenant service B 122 may need to obtain another temporary security token through the permissions service 142 to again access the data storage container 241.

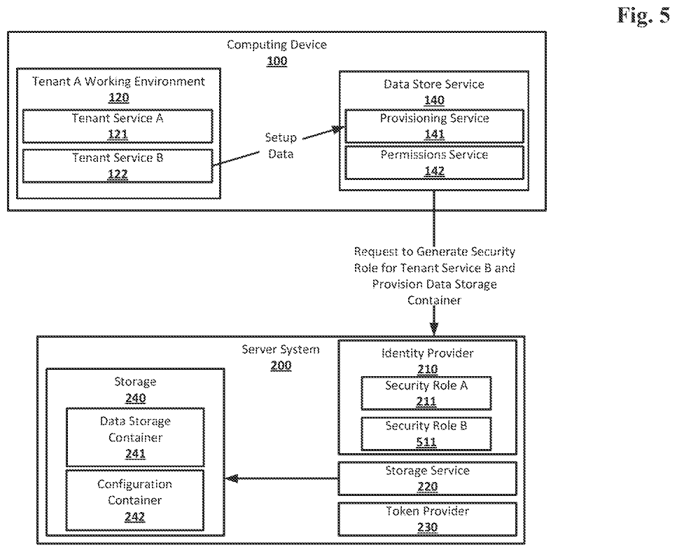

FIG. 5 shows an example arrangement suitable for provisioning and secure access control for storage on public servers according to an implementation of the disclosed subject matter. The tenant service B 122 may send setup data to the provisioning service 141 of the data store service 140. The setup data may include an identification of the tenant service B 122, for example, the service name “Service B”, and an identification of a minimum of one security certificate, for example, a security certificate with an Organizational Unit (OU) field of “tenantA.serviceB”. The setup data may identify security certificates in any suitable manner, including, for example, text or regular expressions that may be matched against any fields in the security certificate or through URIs. The provisioning service 141 may send a request to a server system 200 to provision a data storage container for the tenant service B 122 and generate a security role associated with the tenant service B 122 that can be used to access the data storage container. The provisioning service 141 may also store an association between the tenant service and security certificates in the setup data.

The request from the provisioning service 141 to provision a data storage container for the tenant service B 122 and generate a security role associated with the tenant service B 122 that can be used to access the data storage container may be received at the server system 200. The storage service 220 may generate a new key prefix that may be used with the already-provisioned data storage container 241, as the tenant service B 122 may belong to the same tenant and run in the same working environment, the tenant A working environment 120, as the tenant service A 121 for which the data storage container 241 was already provisioned.

The identity provider 210 may generate a security role B 511. The security role B 511 may be a security role on the sever system 200 that may have a set of permissions allow and delimit access to the data storage container 241 for any user of the security role B 511. For example, the security role B 511 may permit read/write access to the data storage container 241 delimited by a key prefix associated with the security role B 511, which may be different from the key prefix associated with the security role A 211, such that any file stored in the data storage container 241 by a user using the security role B 511 must include that key prefix in the file name and the user may only read and modify files with that key prefix in their filenames. The security role B 511 may be associated with the tenant service B 122, and may have a policy set, for example, by the data store service 140, that may allow the data store service 140, through the permissions service 142, to assume the security role B 511 on the server system 200. The data store service 140 may set a policy in the configuration container 242 that delegates to the permissions service 142. The data store service 140 may also save configuration settings and permissions for the tenant service B 122 to the configuration container 242. Any cryptographic keys used to encrypt and decrypt data in the data storage container 241 for the tenant service B 122 may remain stored on the server system 200 and may be managed by, for example, a key management service of the server system 200.

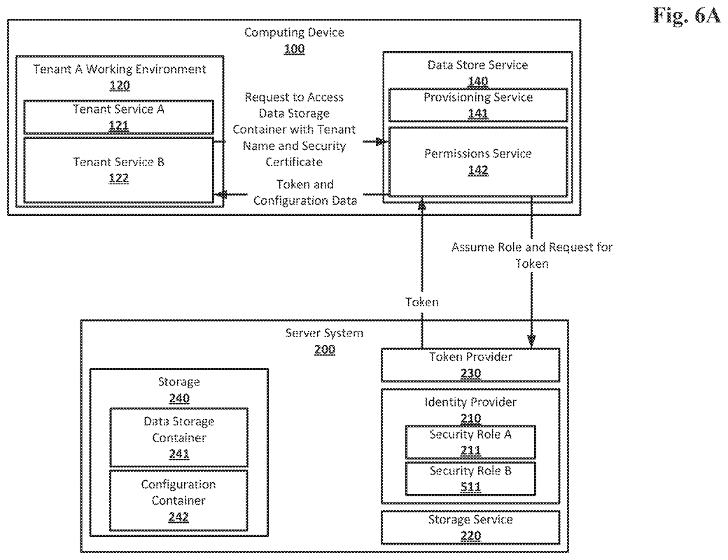

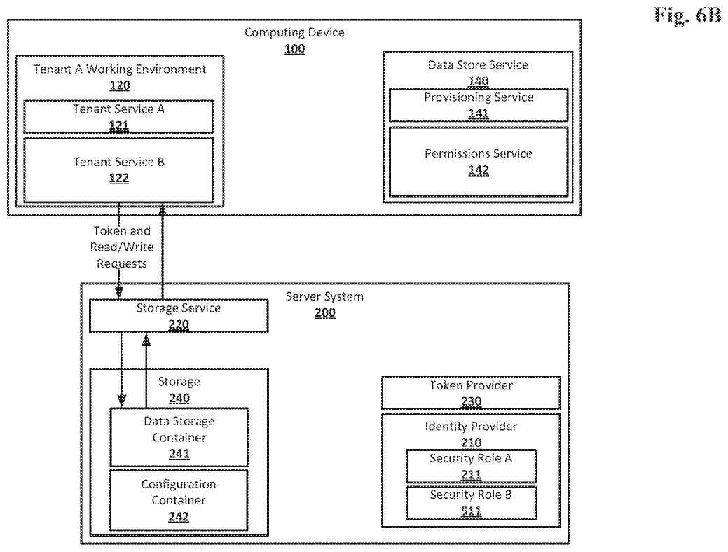

FIG. 6A shows an example arrangement suitable for provisioning and secure access control for storage on public servers according to an implementation of the disclosed subject matter. The tenant service B 122 may send a request to access the data storage container provisioned for it to the permissions service 142 of the data store service 140. The request sent by the tenant service B 122 may include the name of the tenant service whose data the tenant service B 122 wants access to, for example, the “Service B”, and a security certificate that was identified in the setup data that was sent to the data store service 140 by the tenant service whose data the tenant service B 122 wants access to, for example, the security certificate with an OU field of “tenantA.serviceB.”

The permissions service 142 may determine whether the security certificate received from the tenant service B 122 is valid, and whether it was identified in the setup data provided by the tenant service named in the request by the tenant service B 122. For example, the permissions service 142 may determine that the security certificate with the OU field of “tenantA.serviceB” was both identified in the setup data sent by the tenant service named “Service B”, the tenant service B 122, and is valid. The permissions service 142 may then assume the security role associated with the tenant service B 122 on the server system 200, the security role B 511. The permissions service 142 may, for example, prove its identity to the identity provider 210, which may then determine that the policy attached to the security role B 511 permits the permissions service 142 to assume the security role B 511. Using the security role B 511, the permissions service 142 may request a temporary security token that allows access to the data storage container 241 from the token provider 230. The token provider 230 may generate a temporary security token that may allow access to the data storage container 241 based on the set of permissions of the security role B 511. The temporary security token may also have an expiration time. The temporary security token may be sent to the permissions service 142 which may provide the temporary security token and configuration data for the data storage container 241 to the tenant service B 122.

FIG. 6B shows an example arrangement suitable for provisioning and secure access control for storage on public servers according to an implementation of the disclosed subject matter. The tenant service B 122 may use the temporary security token received from the permissions service 142 to interact with the data storage container 241 on the server system 200 using the set of permissions from the security role B 511. The tenant service B 122 may send the temporary security token to the storage service 220 along with any read/write requests for the data storage container 241. The storage service 220 may allow the tenant service B 122 to interact with the data storage container 241 based on the set of permissions of the security role B 511. For example, the storage service 220 may allow the tenant service B 122 to read and modify files in the data storage container 241 that include in their filenames the key prefix that is associated with the security role B 511, which may be different from the key prefix associated with the security role A 211, and may add this key prefix to the filenames of any new files written to the data storage container 241 by the tenant service B 122. The storage service 220 may prevent the tenant service B 122 from accessing files in the data storage container 241 that permissions of the security role B 511 do not permit access to, for example, files stored with other key prefixes in their filenames, as well as files in other data storage containers in the storage 240. The tenant service B 122 may access the data storage container 241 using the temporary security token until the temporary security token expires, at which time the tenant service B 122 may need to obtain another temporary security token through the permissions service 142 to again access the data storage container 241.

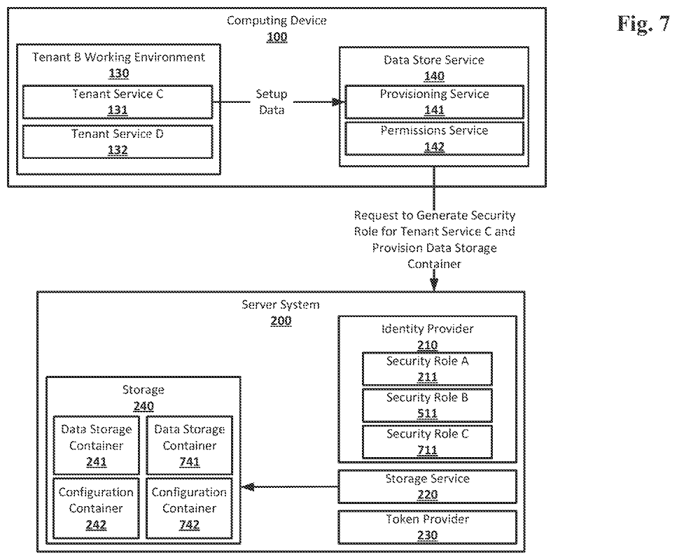

FIG. 7 shows an example arrangement suitable for provisioning and secure access control for storage on public servers according to an implementation of the disclosed subject matter. The tenant service C 131 may send setup data to the provisioning service 141 of the data store service 140. The setup data may include an identification of the tenant service C 131, for example, the service name “Service C”, and an identification of a minimum of one security certificate, for example, a security certificate with an Organizational Unit (OU) field of “tenantB.serviceC”. The setup data may identify security certificates in any suitable manner, including, for example, text or regular expressions that may be matched against any fields in the security certificate or through URIs. The provisioning service 141 may send a request to a server system 200 to provision a data storage container for the tenant service C 131 and generate a security role associated with the tenant service C 131 that can be used to access the data storage container. The provisioning service 141 may also store an association between the tenant service and security certificates in the setup data.

The request from the provisioning service 141 to provision a data storage container for the tenant service C 131 and generate a security role associated with the tenant service C 131 that can be used to access the data storage container may be received at the server system 200. The storage service 220 may provision a data storage container 741 in the storage 240 of the server system 200. The data storage container 741 may be separate from the data storage container 241. The storage service 220 may also set up a configuration container 742, which may store configuration data for the data storage container 741.

The identity provider 210 may generate a security role C 711. The security role C 711 may be a security role on the sever system 200 that may have a set of permissions allow and delimit access to the data storage container 741 for any user of the security role C 711. For example, the security role C 711 may permit read/write access to the data storage container 741 delimited by a key prefix associated with the security role C 711, such that any file stored in the data storage container 741 by a user using the security role C 711 must include that key prefix in the file name and the user may only read and modify files with that key prefix in their filenames. The security role C 711 may be associated with the tenant service C 131, and may have a policy set, for example, by the data store service 140, that may allow the data store service 140, through the permissions service 142, to assume the security role C 711 on the server system 200. The data store service 140 may set a policy in the configuration container 742 that delegates to the permissions service 142. The data store service 140 may also save configuration settings and permissions for the tenant service C 131 to the configuration container 742. Any cryptographic keys used to encrypt and decrypt data in the data storage container 741 for the tenant service C 131 may remain stored on the server system 200 and may be managed by, for example, the key management service of the server system 200.

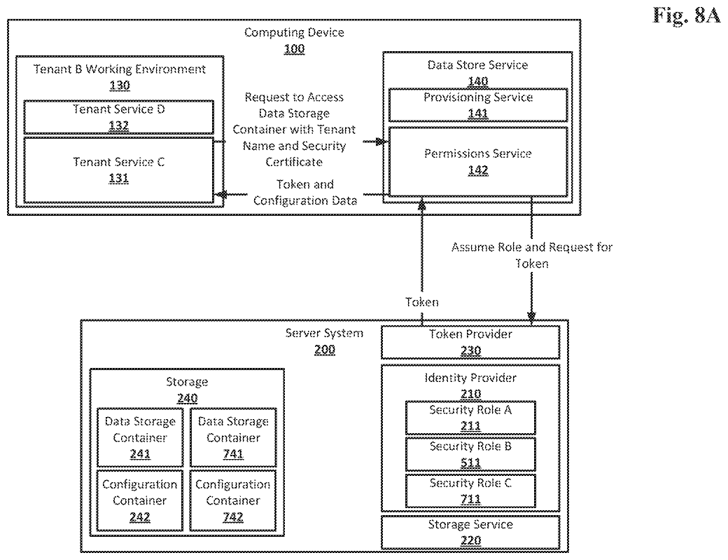

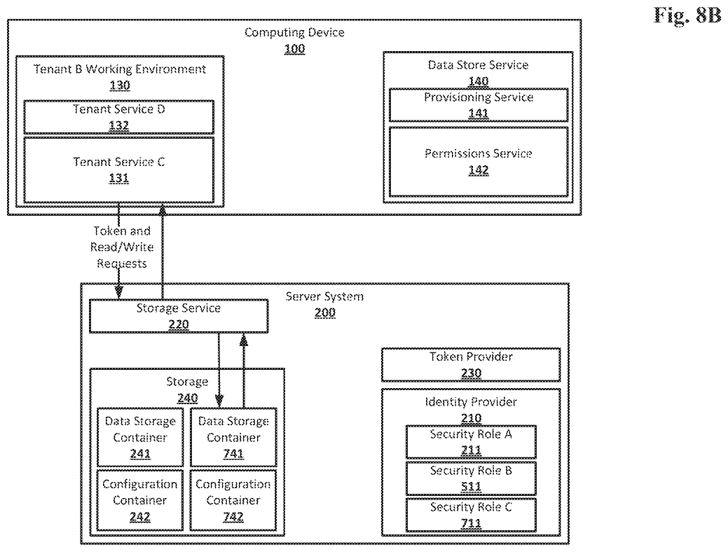

FIG. 8A shows an example arrangement suitable for provisioning and secure access control for storage on public servers according to an implementation of the disclosed subject matter. The tenant service C 131 may send a request to access the data storage container provisioned for it to the permissions service 142 of the data store service 140. The request sent by the tenant service C 131 may include the name of the tenant service whose data the tenant service C 131 wants access to, for example, the “Service C”, and a security certificate that was identified in the setup data that was sent to the data store service 140 by the tenant service whose data the tenant service C 131 wants access to, for example, the security certificate with an OU field of “tenantB.serviceC.”

The permissions service 142 may determine whether the security certificate received from the tenant service C 131 is valid, and whether it was identified in the setup data provided by the tenant service named in the request by the tenant service C 131. For example, the permissions service 142 may determine that the security certificate with the OU field of “tenantB.serviceC” was both identified in the setup data sent by the tenant service named “Service C”, the tenant service C 131, and is valid. The permissions service 142 may then assume the security role associated with the tenant service C 131 on the server system 200, the security role C 711. The permissions service 142 may, for example, prove its identity to the identity provider 210, which may then determine that the policy attached to the security role C 711 permits the permissions service 142 to assume the security role C 711. Using the security role C 711, the permissions service 142 may request a temporary security token that allows access to the data storage container 741 from the token provider 230. The token provider 230 may generate a temporary security token that may allow access to the data storage container 741 based on the set of permissions of the security role C 711. The temporary security token may also have an expiration time. The temporary security token may be sent to the permissions service 142 which may provide the temporary security token and configuration data for the data storage container 741 to the tenant service C 131.

FIG. 8B shows an example arrangement suitable for provisioning and secure access control for storage on public servers according to an implementation of the disclosed subject matter. The tenant service C 131 may use the temporary security token received from the permissions service 142 to interact with the data storage container 741 on the server system 200 using the set of permissions from the security role C 711. The tenant service C 131 may send the temporary security token to the storage service 220 along with any read/write requests for the data storage container 741. The storage service 220 may allow the tenant service C 131 to interact with the data storage container 741 based on the set of permissions of the security role C 711. For example, the storage service 220 may allow the tenant service C 131 to read and modify files in the data storage container 741 that include in their filenames the key prefix that is associated with the security role C 711, and may add this key prefix to the filenames of any new files written to the data storage container 741 by the tenant service C 131. The storage service 220 may prevent the tenant service C 131 from accessing files in the data storage container 741 that permissions of the security role C 711 do not permit access to, for example, files stored with other key prefixes in their filenames, as well as files in other data storage containers in the storage 240. The tenant service C 131 may access the data storage container 741 using the temporary security token until the temporary security token expires, at which time the tenant service C 131 may need to obtain another temporary security token through the permissions service 142 to again access the data storage container 741.

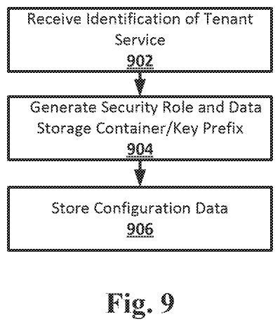

FIG. 9 shows an example procedure suitable for provisioning and secure access control for storage on public servers according to an implementation of the disclosed subject matter. At 902, an identification of a tenant service may be received. For example, the provisioning service 141 of the data store service 140 may receive setup data that may include identification of the tenant service A 121 as part of a request to provision a data storage container for the tenant service A 121. The tenant service A 121 may be identified in any suitable manner, such as, for example, by its service name in the tenant A working environment 120. The security certificates may be identified in any suitable manner, including, for example, by name or regular expression that may be matched to fields of the security certificates. In some implementations, the request may a be a request for access for tenant service A 121 to any suitable service provided by the server system 200. The request may be received from, for example, the tenant service A 121, or may be received from any other suitable source, including, for example, based on a list of tenant services that is read by the provisioning service 141 on startup.

At 904, a data storage container and/or key prefix and a security role may be generated. For example, the provisioning service 141, in response to the request from the tenant service A 121 to provision a data storage container, may send a request to the server system 200 to generate the data storage container 241 or a new key prefix for use with an already provisioned data storage container 241, and a security role that may be used to access the data storage container 241 on the server system 200. If no other tenant service that runs in the tenant A working environment 120 has already had a data storage container provisioned on the server system 200, the storage service 220 may generate a new data storage container, for example, the data storage container 241, along with a configuration container 242 to store configuration data for the data storage container 241. If a data storage container has already been provisioned for another tenant service that runs in the tenant A working environment 120, no new data storage container may be provisioned. The provisioning service 141 may present credentials that verify the identity of the data store service 140 to the identity provider 210 of the server system 200 The identity provider 210 may generate the security role A 211, which may be associated with the tenant service A 121 and may include a set of permissions allowing access to the data storage container 241. The set of permissions may be based on, for example, a key prefix that may be associated with the security role 121 and may delimit the access of a user of the security role A 211 to the data storage container 241. Any number of key prefixes may be used with the data storage container 241. For example, each tenant service from the tenant A working environment 120 for which setup data is provided to the data store service 140 may have its own associated security role, with separate associated key prefix, generated on the server system 200, allowing all of the tenant services to have read and write access to the data storage container 241 while still maintaining data segregation of data belonging to different tenant services and secure control of access to data within the data storage container 241. The provisioning service 141 may cause the identity provider 220 to configure the security role A 211 such that the data host service 140, including the permissions service 142, is allowed to assume the security role A 211 as if it were the tenant service A 121. In some implementations, the security role generated by the identity provider 210 may be allow access to other services of the server system 200 and may include sets of permissions that are appropriate for those services.

At 906, configuration data may be stored. For example, the provisioning service 141 may store configuration data for the data storage container 241 in the configuration container 242.

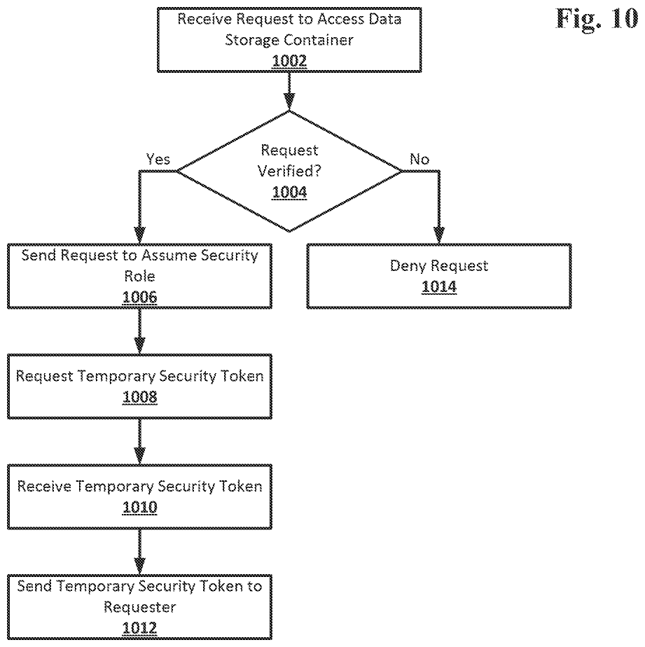

FIG. 10 shows an example procedure suitable for provisioning and secure access control for storage on public servers according to an implementation of the disclosed subject matter. At 1002, a request for access to a data storage container may be received. For example, the permissions service 142 of the data store service 140 may receive a request from a tenant service to access the data storage container 241 on the server system 200. The request may include an identification of a tenant service and a security certificate. The tenant service identified in the request may be the same as or different from the tenant service sending the request. For example, the tenant service A 121 may identify itself in a request, or may identify another tenant service, such as the tenant service B 122. A tenant service may send a request to access a data storage container based on access permissions for a different tenant service. For example, the tenant service B 122 may request to access the data storage container 241 based on the permissions associated with the security role A 211 that was generated based on setup data from the tenant service A 121, allowing the tenant service B 122 to access data belonging to the tenant service A 121 in the data storage container 241 as if it were the tenant service A 121. A tenant service may send a request to access a data storage container on behalf of another tenant service, for example a tenant service that runs in a different working environment. For example, the tenant service D 132, running in the tenant B working environment 130, may request that the tenant service A 121 allow the tenant service D 132 access to the data storage container 241 based on the permissions associated with the security role A 211. In response, if the tenant service A 121 wishes to allow this access, the tenant service A 121 may request access to the data storage container 241 from the data stores service 140 in the same manner as if the tenant service A 121 itself were going to access the data storage container 241.

At 1004, if the request is verified, flow may proceed to 1006. Otherwise, flow may proceed to 1014 and end. The data store service 140 may verify the request to access a data storage container by determining whether the security certificate provided in the request was identified in the setup data that included the tenant service named in the request. For example, if the request from the tenant service A 121 identifies itself, for example, by name, the permissions service 142 of the data host service 140 may determine if the security certificate provided in the request from the tenant service A 121 was identified in the setup data that was provided by the tenant service A 121. The permissions service 142 may also determine if the security certificate provided in the request is valid. If the security certificate is both valid and was identified in the setup data provided by the tenant service identified in the request, the permissions service 142 may verify the request from the tenant service A 121. Otherwise, the permissions service 142 may not verify the request, as the security certificate may not be valid, or may not have been identified in the setup data provided by the tenant service identified in the request. This may prevent a first tenant service from accessing a data in a data storage container that belongs to a second tenant service without both knowing the name of the second tenant service and possessing a security certificate that the second tenant service identified in the setup data it sent to the data store service 140.

At 1006, a request to assume a security role may be sent. For example, the permissions service 142 may send a request to the server system 200 to assume the security role A 211 based on the request from the tenant service A 121 that identified itself. The permissions service 142 may present the identity provider 220 with the credentials that the data store service 140 uses to prove its identity, and the identity provider 220 may allow the permissions service 142 to assume the security role A 211 on the server system 200.

At 1008, a temporary security token may be requested. For example, the permissions service 142, using the security role A 211 on the server system 200, may request a temporary security token that is based on the permissions of the security role A 211 from the token provider 230. The requested temporary security token may, for example, be usable to access the data storage container 241 based on the permissions of the security role A 211 through storage service 220. In some implementations, the temporary security token may be used to access any other service on the server system 200 to which the set of permissions of the security role A 211 allow access.

At 1010, the temporary security token may be received. For example, the permissions service 142 may receive a temporary security token from the token provider 230. The temporary security token may be a token that is usable to access the data storage container 241 based on the permissions of the security role A 211 through storage service 220. The temporary security token may have a limited lifespan.

At 1012, the temporary security token may be sent to the requester. For example, the permissions service 142 may send the temporary security token to the tenant service A 121 in fulfillment of the request received from the tenant service A 121. The permissions service 142 may also send the tenant service A 121 configuration data that the tenant service A 121 may need to access the data storage container 241, such as, for example, a name of the data storage container 241, a base folder of the data storage container 241, and a region of the serer system 200 where the data storage container 241 is located. The tenant service A 121 may use the temporary security token to access the data storage container 241 by, for example, presenting the temporary security token to the storage service 220 along with read and write requests intended for the data storage container 241. The storage service 220 may control access to the data storage container 241 by the tenant service A 121 based on the set of permissions of the security role A 211, for example, allowing the tenant service A 121 to read and modify files in the data storage container 241 that have the key prefix associated with the security role A 211 in their filenames, and ensuring that any new files written to the data storage container 241 by the tenant service A 121 include that key prefix in their filenames. If the tenant service A 121 requested access to the data storage container 241 on behalf of another tenant service, for example, the tenant service D 132, the tenant service A 121 may send the temporary security token to that tenant service.

At 1014, the request may be denied. For example, the permissions service 142 may have been unable to verify the request from the tenant service A 121 due to the security certificate either not being valid or not being identified in the setup data sent by the tenant service identified in the request from the tenant service A 121. The permissions service 142 may deny the request, preventing the tenant service A 121 from accessing the data storage container 241.

Implementations of the presently disclosed subject matter may be implemented in and used with a variety of component and network architectures. FIG. 11 is an example computer 20 suitable for implementing implementations of the presently disclosed subject matter. As discussed in further detail herein, the computer 20 may be a single computer in a network of multiple computers. As shown in FIG. 11, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 12.

Many other devices or components (not shown) may be connected in a similar manner (e.g., document scanners, digital cameras and so on). Conversely, all of the components shown in FIG. 11 need not be present to practice the present disclosure. The components can be interconnected in different ways from that shown. The operation of a computer such as that shown in FIG. 11 is readily known in the art and is not discussed in detail in this application. Code to implement the present disclosure can be stored in computer-readable storage media such as one or more of the memory 27, fixed storage 23, removable media 25, or on a remote storage location.

FIG. 12 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving, at a data store service, from a tenant service, data identifying both the tenant service and a first security certificate;
generating, by the data store service, on a public server, a data storage container that stores data on a physical storage of the public server
generating, by the data store service, on the public server, a security role that is associated with the tenant service and comprises a set of permissions for accessing data in the data storage container;
receiving, at the data store service, from the tenant service, a request to access the data storage container on the public server, the request comprising an identification of the tenant service and the first security certificate;
sending, by the data store service, to an identity provider, credentials and a request to assume the security role;
receiving, by the data store service, from the public server, a temporary security token that allows access to the data storage container based on the set of permissions of the security role; and
sending, by the data store service, the temporary security token to the tenant service.

2. The computer-implemented method of claim 1, wherein the data received from the tenant service identifies a second security certificate and further comprising:
generating, by the data store service, on the public server, a second security role that is associated with the tenant service and comprises a second set of permissions for accessing data in the data storage container;
receiving, at the data store service, from a second tenant service, a request to access the data storage container on the public server, the request comprising the identification of the tenant service and the second security certificate;
sending, by the data store service, to the identity provider, the credentials and a request to assume the second security role;
receiving, by the data store service, from the public server, a second temporary security token that allows access to the data storage container based on the second set of permissions of the second security role; and
sending, by the data store service, the second temporary security token to the second tenant service.

3. The computer-implemented method of claim 2, wherein the second set of permissions comprises permissions different from the permissions in the set of permissions.

4. The computer-implemented method of claim 1, further comprising:
receiving, at the data store service, from a second tenant service, a request to access the data storage container on the public server, the request comprising the identification of the tenant service and the first security certificate or a second security certificate, and wherein the data identifying both the tenant service and the first security certificate further identified the second security certificate;
sending, by the data store service, to the identity provider, the credentials and a request to assume the security role;
receiving, by the data store service, from the public server, a second temporary security token that allows access to the data storage container based on the set of permissions of the security role; and
sending, by the data store service, the second temporary security token to the second tenant service.

5. The computer-implemented method of claim 1, wherein data stored in the data storage container using temporary security tokens that allow access to the data storage container based on permissions in any security role associated with the tenant service comprises a key prefix associated with the security role and further comprising:
receiving, at the data store service, from a second tenant service, data identifying both the second tenant service and a second security certificate;
generating, by the data store service, on the public server, a second security role comprising a second set of permissions for accessing data in the data storage container, wherein the second set of permissions permits access to data in the data storage container that comprises a second key prefix and does not permit access to data in the data storage container that comprises the key prefix associated with the tenant service;
receiving, at the data store service, from the second tenant service, a request to access the data storage container on the public server, the request comprising the second security certificate;
sending, by the data store service, to the identity provider, the credentials and a request to assume the second security role;
receiving, by the data store service, from the public server, a second temporary security token that allows access to the data storage container based on the second set of permissions of the security role; and
sending, by the data store service, the second temporary security token to the second tenant service.

6. The computer-implemented method of claim 5, wherein the set of permissions does not permit access to data in the data storage container that comprises the second key prefix and does permit access to data in the data storage container that comprises the key prefix associated with the tenant service.

7. The computer-implemented method of claim 1, wherein the temporary security token has an expiration time.

8. A computer-implemented system comprising:
a storage; and
a processor that receives, from a tenant service, data identifying both the tenant service and a first security certificate,
generates, on a public server, a data storage container that stores data on a physical storage of the public server,
generates, on the public server, a security role that is associated with the tenant service and comprises a set of permissions for accessing data in the data storage container,
receives, from the tenant service, a request to access the data storage container on the public server, the request comprising an identification of the tenant service and the first security certificate,
sends, to an identity provider, credentials and a request to assume the security role;
receives, from the public server, a temporary security token that allows access to the data storage container based on the set of permissions of the security role; and
sends the temporary security token to the tenant service.

9. The computer-implemented system of claim 8, wherein the data received from the tenant service identifies a second security certificate and wherein the processor further generates service, on the public server, a second security role that is associated with the tenant service and comprises a second set of permissions for accessing data in the data storage container,
receives, from a second tenant service, a request to access the data storage container on the public server, the request comprising the identification of the tenant service and the second security certificate,
sends, to the identity provider, the credentials and a request to assume the second security role,
receives, from the public server, a second temporary security token that allows access to the data storage container based on the second set of permissions of the second security role, and
sends the second temporary security token to the second tenant service.

10. The computer-implemented system of claim 9, wherein the second set of permissions comprises permissions different from the permissions in the set of permissions.

11. The computer-implemented system of claim 8 wherein the processor further receives from a second tenant service, a request to access the data storage container on the public server, the request comprising the identification of the tenant service and the first security certificate or a second security certificate, and wherein the data identifying both the tenant service and the first security certificate further identified the second security certificate,
Sends, to the identity provider, the credentials and a request to assume the security role;
receives, from the public server, a second temporary security token that allows access to the data storage container based on the set of permissions of the security role, and
sends the second temporary security token to the second tenant service.

12. The computer-implemented system of claim 11, wherein data stored in the data storage container using temporary security tokens that allow access to the data storage container based on permissions in any security role associated with the tenant service comprises a key prefix associated with the security role and wherein the processor further receives, from a second tenant service, data identifying both the second tenant service and a second security certificate,
generates, on the public server, a second security role comprising a second set of permissions for accessing data in the data storage container, wherein the second set of permissions permits access to data in the data storage container that comprises a second key prefix and does not permit access to data in the data storage container that comprises the key prefix associated with the tenant service,
receives, from the second tenant service, a request to access the data storage container on the public server, the request comprising the second security certificate,
sends, to the identity provider, the credentials and a request to assume the second security role,
receives, from the public server, a second temporary security token that allows access to the data storage container based on the second set of permissions of the security role, and
sends the second temporary security token to the second tenant service.

13. The computer-implemented system of claim 12, wherein the set of permissions does not permit access to data in the data storage container that comprises the second key prefix and does permit access to data in the data storage container that comprises the key prefix associated with the tenant service.

14. The computer-implemented system of claim 8, wherein the temporary security token has an expiration time.

15. A system comprising: one or more computers and one or more non-transitory storage devices storing instructions which are operable, when executed by the one or more computers, to cause the one or more computers to perform operations comprising:
receiving, at a data store service, from a tenant service, data identifying both the tenant service and a first security certificate;
generating, by the data store service, on a public server, a data storage container that stores data on a physical storage of the public server
generating, by the data store service, on the public server, a security role that is associated with the tenant service and comprises a set of permissions for accessing data in the data storage container;
receiving, at the data store service, from the tenant service, a request to access the data storage container on the public server, the request comprising an identification of the tenant service and the first security certificate;
sending, by the data store service, to an identity provider, credentials and a request to assume the security role;
receiving, by the data store service, from the public server, a temporary security token that allows access to the data storage container based on the set of permissions of the security role; and
sending, by the data store service, the temporary security token to the tenant service.

16. The system of claim 15, wherein the data received from the tenant service identifies a second security certificate, and wherein the one or more computers and one or more non-transitory storage devices further store instructions which are operable, when executed by the one or more computers, to cause the one or more computers to further perform operations comprising:
generating, by the data store service, on the public server, a second security role that is associated with the tenant service and comprises a second set of permissions for accessing data in the data storage container;
receiving, at the data store service, from a second tenant service, a request to access the data storage container on the public server, the request comprising the identification of the tenant service and the second security certificate;
sending, by the data store service, to the identity provider, the credentials and a request to assume the second security role;
receiving, by the data store service, from the public server, a second temporary security token that allows access to the data storage container based on the second set of permissions of the second security role; and
sending, by the data store service, the second temporary security token to the second tenant service.

17. The system of claim 15, wherein the second set of permissions comprises permissions different from the permissions in the set of permissions.

18. The system of claim 17, wherein the one or more computers and one or more non-transitory storage devices further store instructions which are operable, when executed by the one or more computers, to cause the one or more computers to further perform operations comprising:
receiving, at the data store service, from a second tenant service, a request to access the data storage container on the public server, the request comprising the identification of the tenant service and the first security certificate or a second security certificate, and wherein the data identifying both the tenant service and the first security certificate further identified the second security certificate;
sending, by the data store service, to the identity provider, the credentials and a request to assume the security role;
receiving, by the data store service, from the public server, a second temporary security token that allows access to the data storage container based on the set of permissions of the security role; and
sending, by the data store service, the second temporary security token to the second tenant service.

19. The system of claim 15, wherein data stored in the data storage container using temporary security tokens that allow access to the data storage container based on permissions in any security role associated with the tenant service comprises a key prefix associated with the security role and wherein the one or more computers and one or more non-transitory storage devices further store instructions which are operable, when executed by the one or more computers, to cause the one or more computers to further perform operations comprising:
receiving, at the data store service, from a second tenant service, data identifying both the second tenant service and a second security certificate;
generating, by the data store service, on the public server, a second security role comprising a second set of permissions for accessing data in the data storage container, wherein the second set of permissions permits access to data in the data storage container that comprises a second key prefix and does not permit access to data in the data storage container that comprises the key prefix associated with the tenant service;
receiving, at the data store service, from the second tenant service, a request to access the data storage container on the public server, the request comprising the second security certificate;
sending, by the data store service, to the identity provider, the credentials and a request to assume the second security role;
receiving, by the data store service, from the public server, a second temporary security token that allows access to the data storage container based on the second set of permissions of the security role; and
sending, by the data store service, the second temporary security token to the second tenant service.

20. The system of claim 19, wherein the set of permissions does not permit access to data in the data storage container that comprises the second key prefix and does permit access to data in the data storage container that comprises the key prefix associated with the tenant service.
